(19) United States
(12) Patent Application Publication
(10) Pub. No.: US 2013/0091218 A1
(43) Pub. Date: Apr. 11, 2013

(54) SYSTEM AND METHOD FOR PROVIDING CONTENT SERVICES TO NETWORK USERS WITHOUT INSTALLATION OF CLIENT SOFTWARE

(71) Applicants: Amiad Solomon, Kfar Adumim (IL); Roy Zisapel, Tel-Aviv (IL); Nitzan Ben-Zvi, Hogla (IL)

(72) Inventors: Amiad Solomon, Kfar Adumim (IL); Roy Zisapel, Tel-Aviv (IL); Nitzan Ben-Zvi, Hogla (IL)

(21) Appl. No.: 13/613,144

(22) Filed: Sep. 13, 2012

Related U.S. Application Data
(60) Provisional application No. 61/534,431, filed on Sep. 14, 2011.

(51) Int. Cl. H04L 29/06

(52) U.S. Cl. CPC H04L 65/403
USPC 709/204

(57) ABSTRACT

System and method for reviewing at a service integration unit data returned to a user from the network and adding content to the returned data, wherein the added content is selected according to parameters of the user. The content may include promotional programs, software downloads, software services, advertisements, targeted commercial content, network service provider related services, search bar, links that appear in a source page called for by the user and suspected as malicious and cloud services.

### CROSS REFERENCE TO RELATED APPLICATIONS

This application claims the benefit of U.S. Provisional Application Ser. No. 61/534,431, filed Sep. 14, 2011, which is hereby incorporated by reference in its entirety.

### BACKGROUND OF THE INVENTION

Internet based services for ‘injecting’ content to an Internet user are known. Some of these may rely on information related to the requests for Internet pages and links issued by the user when loading another page, as embedded in the Internet call. However these services require either the intermediation of another service or the installation of a ‘client’ piece of software on the user's computer. (An example of existing formats today: Toolbars, side bars, browsers extensions etc).

### SUMMARY OF THE INVENTION

Systems and methods are disclosed for routing copy of content of a user's request for a web site page, to a dedicated service, and server so that the content of the page request is readable and may be stored and analyzed by that service. Additionally, responses to the web page request may also be routed to the dedicated service. Additionally, the dedicated service may provide additional content and/or services to the content and controls returned in response to the web page request. The additional content and/or service may be superimposed onto the display of the returned content thus creating a floating desktop (or toolbar like display) on the user's display. According to embodiments of the present invention the content and controls received from the user and/or in response to his page request, may be analyzed according to several parameters so as to profile the user's surfing profile. This profile may be used to determine what type, structure, frequency, and substance of content should be added to the user's loaded web page.

According to embodiments of the present invention there is provided a method for providing content services to a user of a network, the method may include: reviewing at a service integration unit data returned to a user from the network and adding content to the returned data, wherein the added content may be selected according to parameters of the user.

Furthermore, according to embodiments of the present invention the method may include registering the user to the content services at the service integration unit prior to reviewing the data.

Furthermore, according to embodiments of the present invention the service integration unit may be part of an Internet Service Provider network.

Furthermore, according to embodiments of the present invention the service integration unit may be part of a local browser of the user.

Furthermore, according to embodiments of the present invention the method may include retrieving the content from an infrastructure selected from: a database located at a dedicated content server and the network.

Furthermore, according to embodiments of the present invention the method may include providing a software development kit to enable integrating services into the content services.

Furthermore, according to embodiments of the present invention the method may include rendering, by a browser of the user, additional content from the network to complement the content.

Furthermore, according to embodiments of the present invention the method may include rendering, by a browser of the user, additional content from a database located on a dedicated content server to complement the content.

Furthermore, according to embodiments of the present invention the method may include presenting the content to the user in a form of a floating desktop.

Furthermore, according to embodiments of the present invention the content may selected from the list of: promotional programs including cash-back programs, software downloads, software services, advertisements, targeted commercial content, network service provider related services, search bar, links that appear in a source page called for by the user and suspected as malicious and other cloud services.

According to embodiments of the present invention there is provided a data processing system, the system may include a processor; and a computer usable non-transitory medium connected to the processor, wherein the computer usable non-transitory medium may include a set of instructions for providing content services to a user of a network, wherein the processor may be designed to carry out a set of instructions to review data returned to a user from the network; and to add content to the returned data, wherein the added content may be selected according to parameters of the user.

Furthermore, according to embodiments of the present invention the processor may be designed to carry out a set of instructions to register the user to the content services prior to reviewing the data.

Furthermore, according to embodiments of the present invention the processor may be part of an Internet Service Provider network.

Furthermore, according to embodiments of the present invention the processor may be part of a local browser of the user.

Furthermore, according to embodiments of the present invention the data processing system may include a dedicated content server, wherein the processor may designed to carry out a set of instructions to retrieve the new content from a database located on the dedicated content server.

Furthermore, according to embodiments of the present invention the processor may be designed to carry out a set of instructions to retrieve the new content from the network.

Furthermore, according to embodiments of the present invention the processor may be designed to carry out a set of instructions to provide a software development kit to enable integrating services into the content services.

Furthermore, according to embodiments of the present invention the data processing system may include a browser of the user to render additional content from the network to complement the content.

Furthermore, according to embodiments of the present invention the data processing system may include a browser of the user to render additional content from a database located on a dedicated content server to complement the content.

Furthermore, according to embodiments of the present invention the processor may be designed to carry out a set of instructions to prepare the content to the user in a form of a floating desktop.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for providing content services according to embodiments of the present invention;

FIG. 2 is a schematic illustration of another system for providing content services according to embodiments of the present invention;

FIG. 3 which is a schematic process flow diagram for providing content services according to embodiments of the present invention;

FIG. 4 is a schematic illustration of another system for providing content services according to embodiments of the present invention; and

FIG. 5 is a schematic illustration of yet another system for providing content services according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

According to embodiments of the present invention there is provided a platform that may allow a provider of network services, such as Internet Service Provider (ISP), WiFi service provider, Mobile carrier, TV operator, IPTV operator, Cable operator, Satellite operator, etc. to provide a user of a computer network (such as the Internet, or World Wide Web (WWW), hereinafter referred to as network) software services, content services, search services, media services, etc. without the need to install and/or pre-configure the working environment of the user. Such new/additional services can be integrated automatically into the user's browser (or any other type of program and service enabling surfing the network) while accessing the network (such as the Internet, or World Wide Web (WWW)) through the network. According to embodiments of the present invention these features and abilities may be available to a user using any kind of network browser and accessing substantially any type of web page and content. Accessing the service while not connected to the internet (or not accessing the network) may be possible by installing client side agent or a user interface (UI) program, such as a browser toolbar or extension, that will host the user selected services and environment. As an option, the services can be integrated with the ‘end user’ or other devices (such as laptop, router, modem, television sets, Xbox, game consoles, etc) and will allow access to content and services when connected to any network.

The platform, according to embodiments of the present invention, may enable a dedicated service to receive a copy of the data and controls flowing from the user's work station to the network, and to receive copy of data and controls flowing to that user's workstation. This dedicated service may further review and analyze the flow of data and control and extract from it various kinds of information. This dedicated service may provide data collection service. The analysis may provide very detailed and accurate profiling of the user or users accessing the network.

The platform, according to embodiments of the present invention, may provide wide range of services originating from different Software and Software-as-service (SAS) vendors. As used herein SAS relates to a software and associated data that are hosted on the network resources and delivered to the user via the network. A user of the service, according to the present invention may experience the service of same as personal ‘floating desktop’. The term ‘floating desktop’, as is used in the description of the invention herein below, may have the meaning of content, enabled links and controls that are presented to the user over at least part of the screen displaying content received from the currently browsed web page. The user of a service according to the invention may choose his one or more services and may organize the appearance and features of his own ‘floating desktop’ as may be required for him. The operation of the service according to the invention may be in one of several modes. While using the service in ‘auto integrated’ mode (this mode may be defined as the default mode of operation of the service, however, other mode may be defined as the default mode), the platform's backend servers may integrate the service into the user's browser by attaching a new floating layer to the displayed content. The term ‘floating layer’ relates here to displayable content that may be displayed by the ‘floating desktop’ over at least part of the display of the currently browsed web page on the screen. This new layer may host the desired service(s) and tools that the user may wish to operate. The visual appearance of the floating layer can be tuned according to the user's preferences (size, location, skin etc). Each one of the services selected by the user for serving/providing content, according to embodiments of the invention, may have its own visual properties including indicators and GUI behavior. In some cases, in order to provide via the floating desktop additional services and information to the user, the service of the invention can expand its ‘working area’ outside the range of the original floating desktop borders, as may be required. Additionally or alternatively a service according to embodiments of the invention may provide added content and services in a client-side pre-installed manner.

One advantage of a system according to embodiments of the present invention is the option to be installed as part of the Internet Service Provider (ISP) network. This optional implementation may reduce the access time for customers of the service provider and may allow better service, as expressed by network response time, availability of network services and contents, etc., when using services installed on, or available from cloud computing environment.

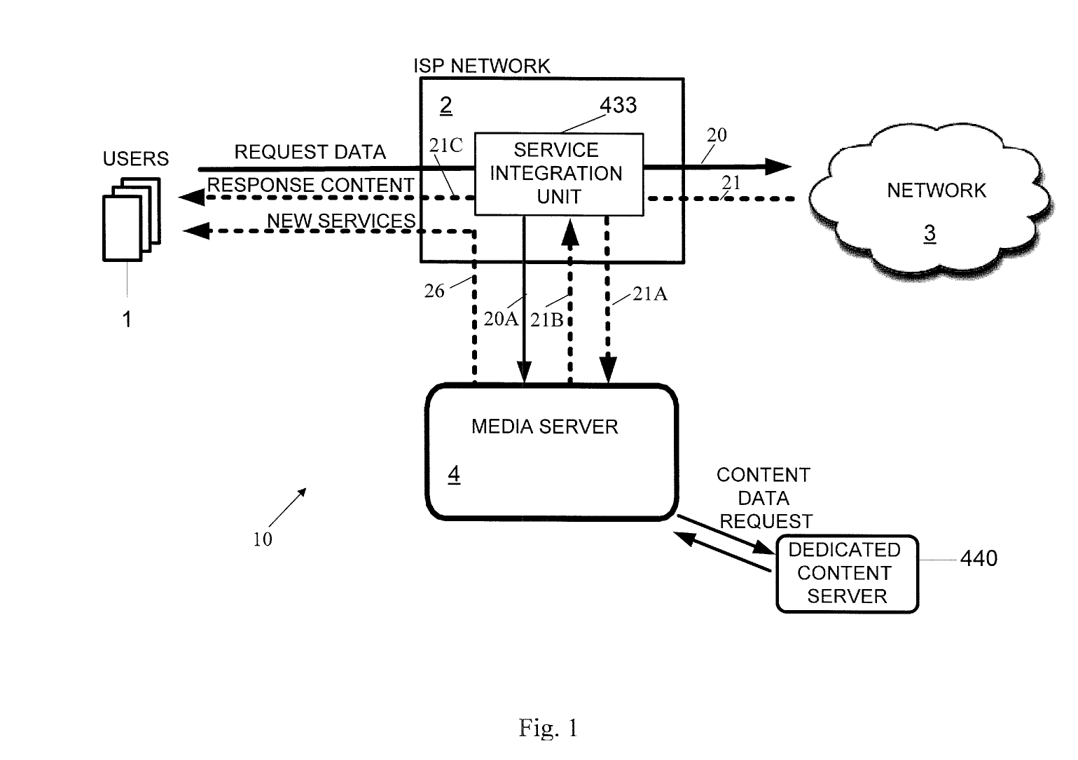

Reference is made now to FIG. 1, which is a schematic illustration of system 10 for providing content services according to embodiments of the present invention. System 10 may comprise a wide area network 3, such as the Internet to which ISP network 2 is connected for enabling the connection of one or more users 1 to network 3. System 10 may further include, according to embodiments of the invention, media server 4 and dedicated content server 440 which is in active communication with media server 4. Media server 4 may be embodied as a stand alone server or servers or as part of server or servers used also for other jobs. Server 4 may function as a transparent proxy in the ISP backend network. System 10 may further comprise service integration unit 433 in active communication with ISP network 2. Service integration unit 433 may be embodied as part of ISP network 2, as part of a local browser of user 1, or as a separate unit, having transparent access to traffic of content and control passing through ISP network 2. As depicted in FIG. 1, data requests issued by user 1 (presented by arrow line 20) may invoke response from network 3 (presented by arrow line 21). Each data returned from the internet (line 21) may be enriched by service integration unit 433 or routed by service integration unit 433 to media server 4 (line 21A), modified to include the additional content and/or controls (represented by arrow line 21B), to create composed stream of data and controls (represented by arrow line 21C). The additional content and/or controls may be presented to user 1 as floating desktop platform (not shown) and/or be presented to user 1 as options activated via the floating desktop platform.

System 10 enables virtually unlimited access to the browsing and internet data of user 1. As is depicted in the drawing when forwarding the request (line 20) to the defined web site (part of Network 3), service integration unit (433) may forward a copy of the request to media server 4 (line 20A) and use the returned data (line 21A) for profiling purposes. Subject to users and legal approval the following behavioral data collection may be gathered, established, maintained and used:

Input data—data of accessed internet resources, returned content from the web, etc.

Analyzed user information—using the raw data collected as mentioned above, the following user related data can be collected for each user: area if interests as derived from the browsable sites; this relates to temporary trends or behavioral (for example, if the user is looking for vacation, this area of interest might become temporary property, sport related interest is ongoing behavioral property); used services (SAS, email, bank, etc.); usage of patterns (frequency, time-of-day (TOD), time of month (TOM), duration, etc.); user responses (analyze the options that the user has been viewing and the chosen option); general browsing habits (such as frequency, duration, patterns); etc. The data obtained this way may be used, according to embodiments of the present invention, for personalized services such as commerce offering, relevant content, search results, etc.

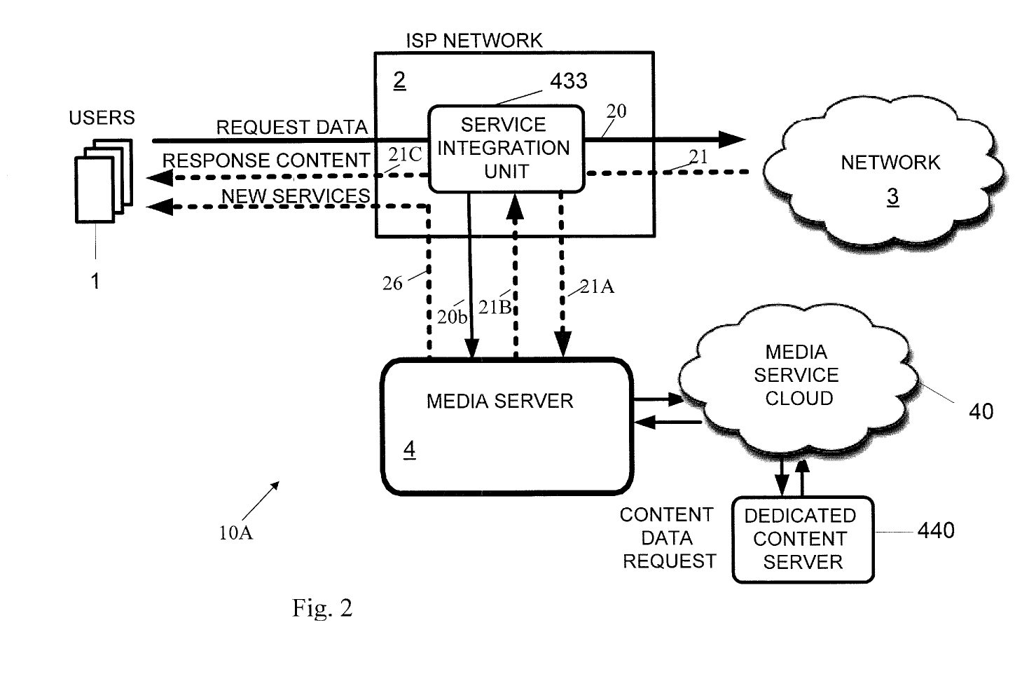

Reference is made now to FIG. 2 which is a schematic illustration of system 10A for providing content services according to embodiments of the present invention. System 10A is substantially same as system 10, except for the inclusion of media service cloud 40, which is a computing cloud service providing media contents in response to calls or content from media server 4.

The data flow in system 10 and/or system 10A may be as follows. User 1 may access a large area network such as Network 3 through the ISP network 2. This process may begin with a URL request sent from the user browser software (installed on the desktop/laptop/mobile/other of user 1). The request is routed to the Internet and in response, HTML based content may be sent back to the user's browser application. The user's browser application, such as an Internet browser, may be adapted to parse the data received in the response and to display the displayable content to the user. As part of the ISP backend network, the data may be routed through routers, switches and other backend network devices. As part of the content services of the present invention, service integration unit 433 may be used to enrich the content received in response to the user's request with the new services and content routing information. Enriching of the received content may be done by reviewing the data returned to the user from the network and adding additional content to the returned data. The additional content may be selected according to parameters of the user. For example, the parameters of the user may be derived from the analyzed user information described hereinabove. Additionally or alternatively, service Integration unit 433 may route the traffic (line 21A) to Media Server 4 that may perform the data enrichment. In such implementation the enriched data may be routed (line 21B) through service integration unit 433 back to the user (line 21C). The returned data may be enriched by content retrieved from database located at dedicated content server 440 and/or from network 2.

According to some embodiments of the present invention, the user may have to register to the content services of the present invention prior to receiving the content services. Alternatively, registration of the user may not be required, and the content services may be supplied to the user without user registration.

Once the content is processed by the user's browser, the browser may initiate a service request, which may be sent to media/content server 4 and the relevant content and services (such as predefined content and services) may be sent to the user. A service request may include rendering, by the browser of the user, additional content from network 2 and/or from a database located, for example, on dedicated content server 440 to complement the content already added by the content service of embodiments of the present invention.

According to embodiments of the present invention the ‘floating desktop’ which may be presented on the user's work station may be designed to host virtually any software service, tool or content that can be accessed via any standard browser and can be executed on the user's computer. The system according to embodiments of the invention may provide a software development kit (SDK) and relevant interfaces that can be used to integrate new services/tools into the service according to the invention. Beside the user oriented services, the desktop may be adapted to host, for example, commercial content and sales promotion content that may be controlled by ISP network 2 and/or media server 4.

Examples of services, content and offers that may be offered and/or provided by system 10, 10A are given below.

Generic cloud services: system 10, 10A may provide access to developers of cloud services based solutions to integrate their services into the floating desktop, the actual usage of the service may be made from the service provider hosting center (in this case, the SAS will act like distributed control system (DCS)). According to the specific service, special settings, preferences and indications may be activated from the floating desktop area, such services might open another web page (in the browser, use popup forms or trigger client side process such as installation, download, execution of a process etc.). Example for cloud service may be search for data, backup content, provide antivirus service and other security related services, email service, word processing software such as Office 365 or other word processing, data manipulation and/or visualization services), ERP/CRM related services (such as Saleforce), link to social network(s) such as Facebook® link, monitoring services, weather gauge, news in RSS format and other services which does not require installation on the user's workstation.

Security and content verification: This service may check the web links that appear in the source page called for by user 1, notify user 1 on links suspected as malicious/affected with viruses. This service may be carried out by: on the server side content unit's plug-in may extract the links from the returned web page and send it to the relevant Dedicated Content Server (DCS). The client side application of the floating desktop may query the server for results till the data becomes available and display the relevant findings indications. As an option (according to the user preferences) proactive alert notification may be initiated.

Search services: This service may provide enhanced search services to the end user. The server side backend may serve as search agent. Search requests may be sent to this server and may be executed asynchronously. Examples of services that may be provided by this agent are:
Merge the search results from more than one search engine
Route the search request to specific search engine
Integrate link certification data into the search results
   Additionally, the floating desktop of user 1 may host a search bar enabling the user to search the web directly from the bar itself. Additional to this service, the new platform might replace the default search engine defined for the user's installed browsers and default home pages.

Network service provider related services: The floating desktop according to the present invention may provide user 1 direct access to the user account and to additional add-on service(s) provided by the network service provider (such as link verification, sending SMS, Media services, etc.). In order to enable this feature it is possible to integrate the service provider's services dashboard into the floating desktop. As a result of this service, user 1 may experience easy direct access to his account and service related data.

Promotion of commercial data: the services offered by system 10, 10A may utilize the desktop space and the collected user data to promote targeted commercial content. This may be carried out by using the floating desktop area to display content to the users. The content may range from standard advertisements to custom tailored integrations and promotional programs. The content visibility may be one of the following:
Custom targeted indications and notifications coming from the desktop area
Advertisement on the floating desktop

Trading targeted and statistical data: this may be done by using the collected user's statistical data to provide analyzed statistical information. For example—trend analysis, software usage statistics, shopping habits, etc. Statistical analysis of the data and requested traffic may be done along time, to identify and record surfing trends and habits.

Promotion of downloadable software applications: as part of the offering the floating desktop may promote download the client a version of the service or any other software service that can be installed on the client device.

Promotional programs: The service may provide promotional offers such as bonuses, coupons, cash-back services etc. to the end user. The service may display the offers to the users according to their usage history, reported profile or area of interests, collected profile, etc. together with the actual content they are browsing to. The offers displayed by the system may depend on the actual available offers and on any other business related parameter supported by the system. For example, the system may keep a database relating between similar equivalent or related goods, the various suppliers of these goods and promotional programs offered by the suppliers for the goods. This service may check whether target websites to which a URL request was sent from the user browser software provides promotional programs and send indication to the user of such promotional programs, for example, via the ‘floating desktop’. If the target web site does not offer promotional programs, the service may search for a competitor site that sell similar goods but does offer promotional programs to the user. The service may list the competitor sites to the user at the ‘floating desktop’. Similarly, the service may analyze user data to find out the specific goods the user is looking for and present to the user, for example at the ‘floating desktop’, a list of supplier sites that sell these goods or related goods and offer promotional programs. Another usage scenario may present offers to the user according to his/her search activities as made on one of the search engines, such as bing, google, etc.

According to embodiments of the present invention the service may provide seamless cash-back programs to the user. As used herein seamless cash-back programs may refer to cash-back programs that are preformed without requiring that the user browse to a merchant web page through the cash-back website.

Content services according to embodiments of the present invention review data sent by the user and data returned to the user, and are able to add content to data returned to the user, there is no need that the user browses to the merchant webpage from a webpage of the cash-back service. Thus, the requirement that the user browse to the merchant webpage through the cash-back website is cancelled.

According to embodiments of the present invention a message with cash-back rates may be displayed automatically to the user, in the ‘floating desktop’ or via a pop up, in page ad, html injection etc., when the user browses to a merchant web page which is engaged with the cash-back service, or when the user searches for a product or service, or when the content service decides, for example, based on analysis of the user information and browsing activities, that such a referral would be beneficial for the user. The user does not have to browse to a destination site, e.g., a coupon site, a cash-back site etc., to enjoy the cash-back service, rather the deals and cash-back are displayed on the general browsing pages presented to the user, for example in the ‘floating desktop’.

For example if a user browses a merchant that is engaged with the cash-back program, the content services of embodiments of the present invention may display cash-back rates on the floating desktop area. In case the user browses to a site that is not engaged with the cash-back program, a message recommending the user to browse to a merchant that is engaged with the cash-back program may be displayed. Additionally, if a user searches for a product or service on a search engine, e.g., Google™, an ad with websites of merchants that are engaged with the cash-back program may be displayed on the floating desktop area. Similarly, ads directing to merchants that are engaged with the cash-back program may be displayed, based on a profile that was build on the user behavior and browsing, searching and purchasing history.

A user may redeem his cash-back money accumulated, or access his accounts by clicking on a button presented on the ‘floating desktop’ with no need to browse to a destination site. The user can receive his money via an electronic payment service (i.e. PayPal™), check, cash or other format of points.

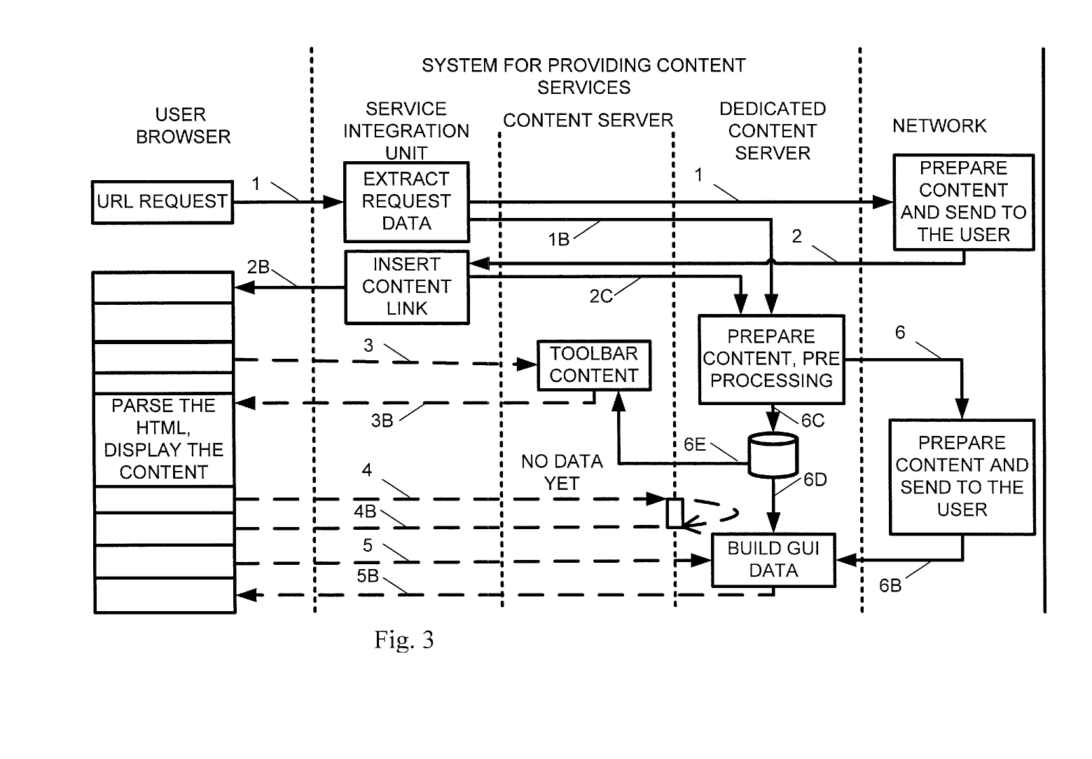

Reference is made to FIG. 3 which is a schematic process flow diagram for providing content services according to embodiments of the present invention. When a user opens the browser and types a URL, the request (1) is routed via a proxy device (such as service integration unit 433 of FIG. 1) to the internet web server (part of network 3 in FIG. 1). The proxy device may extract the request and may send the information (1b) to a content server (such as media server 4 in FIG. 1). The returned data sent from the server (2) is routed through the proxy device on the way back to the client browser, the proxy device modifies the returned data and add new content that initiate the new services made available according to embodiments of the present invention (2b) (as described hereinabove). Concurrently to this modification, the proxy server sends (2c) the returned data (if needed, according to the services registered/selected by the user) to the dedicated content server (such as dedicated content server 440 in FIG. 1). This server (the DCS) starts processing the data and prepares the information for the user. Once the user's browser receives the modified HTML content, the browser starts rendering the respective content, when start processing the new content (added by the proxy device, described as 2b in FIG. 3), the browser accesses (i.e. sends data request 3) the content server for the additional content to be displayed. The content server using the predefined user preferences and historic data (6e) prepares the floating desktop content and sends it (3b) to the user. Additional http requests may be initiated by the client side browser to complete the missing content that is required by the floating desktop (4, 5, . . . ). For each content request (4, 5, . . . ) a dedicated content server responsible for the content may either reply with “not ready” (4b) or with updated GUI data (5b) for display. The DCS uses the data prepared earlier and stored in the temporary database (6c, 6d) or uses web based content (6b).

According to some embodiments of the present invention, the proxy functionality may be implemented as integrated part of the media server 4 (depicted in FIG. 1). In such implementation the service integration unit 433 (depicted in FIG. 1) may route the traffic to and from media server 4 as displayed in FIG. 1.

Implementation examples: The entire service of system 10, 10A may be provided from single or distributed servers ‘farms’ installed locally on the ISP network or by central cloud (or clouds) providing services to more than one ISP networks. See for example the architecture of system 10A in FIG. 2. The end users, such as user 1, of the ISP may be able to use the service of system 10, 10A without having to perform any installation or changes to their local browsing devices. Once using the ISP network—the new services made available according to embodiments of the present invention (as described hereinabove) will be integrated automatically into the browser. Integration of the additional content into the user's web stream may be done using transparent proxy device installed as part of the ISP network (such as service integration unit 433 in FIG. 1). Collecting statistical information and behavioral data related to the user may be done using the same device. Pre-processing of the data can be done using dedicated products (for example Inflight from Radware Ltd.).

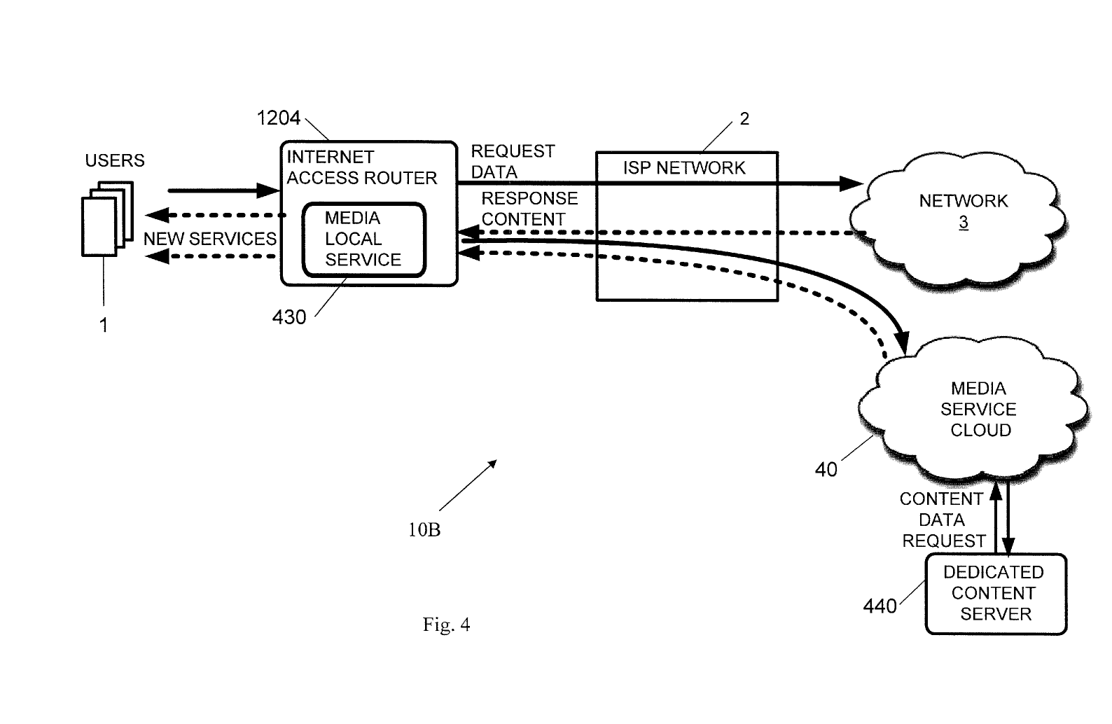

Remote services that will be provided to non ISP users may be provided directly from the Internet gateways (like the DSL routers or the enterprise gateways). In this case, the service connectivity will be made from the client side without being depended on the ISP network, as depicted in FIG. 4, which is a schematic illustration of system 10B for providing content services according to embodiments of the present invention. User 1 may establish connectivity with dedicated content server 440 directly via Internet access router 1204 and, optionally, via media service cloud 40. Once such connectivity has been established the operation of system 10B in providing services according to embodiments of the present invention to user 1 is similar to that of system 10 or 10A discussed above. Locally installed router 1204 (for example DSL/Cable modem/other) may communicate with media service cloud 40 to send and receive service related data in the same way as described with respect to system 10 or 10A. As an option, the user's browser (or another service allowing content presentation/displaying) plug-in may be installed on the user's content display device (such as personal computer, TV set etc.) and may integrate the content into the displayed content.

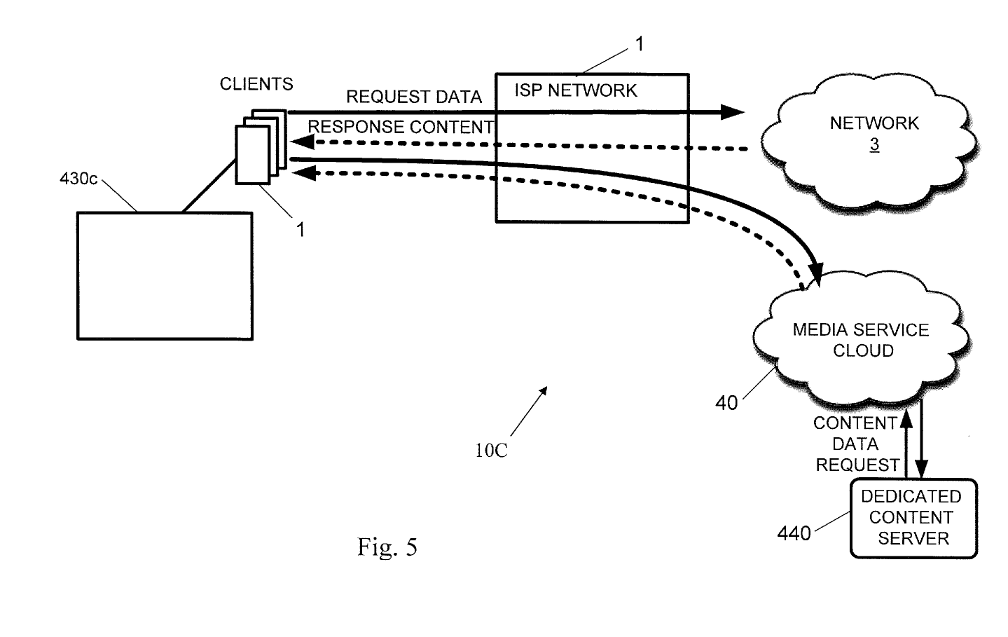

Reference is made now to FIG. 5, which is a schematic illustration of system 10C for providing content services according to embodiments of the present invention. A client side utility 430c may be installed on user 1 content display device (such as web browsing installed on personal computer, TV set etc.) and may be used to integrate the web content directly into the displayed content. As an option the plug-in module (such as client side utility 430c) may be configured to send statistical and behavioral data to the media servers of the present invention. Other aspects of the operation of system 10C are analogous to the operation of system 10B described above.

Some embodiments of the present invention may be implemented in software for execution by a processor-based system, for example, media server 4. For example, embodiments of the present invention may be implemented in code and may be stored on a non-transitory storage medium having stored thereon instructions which can be used to program a system to perform the instructions. The non-transitory storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for providing content services to a user of a network, the method comprising:
reviewing at a service integration unit data returned to said user from the network; and
adding content to the returned data,
wherein the added content is selected according to parameters of the user.

2. The method of claim 1, comprising
registering the user to the content services at the service integration unit prior to reviewing the data.

3. The method of claim 1, wherein the service integration unit is part of an Internet Service Provider network.

4. The method of claim 1, wherein the service integration unit is part of a local browser of the user.

5. The method of claim 1, further comprising:
providing a software development kit to enable integrating services into the content services.

6. The method of claim 1, further comprising:
rendering, by a browser of the user, additional content from the network to complement the content.

7. The method of claim 1, further comprising:
rendering, by a browser of the user, additional content from a dedicated content server to complement the content.

8. The method of claim 1, further comprising:
presenting the content to the user in a form of a floating desktop.

9. The method of claim 1, wherein the content services is selected from the list consisting of promotional programs, software downloads, software services, advertisements, targeted commercial content, network service provider related services, search bar, links that appear in a source page called for by the user and suspected as malicious and cloud services.

10. The method of claim 9, wherein the content services is a cash-back program.

11. A data processing system comprising:
a processor; and
a computer usable non-transitory medium connected to the processor, wherein the computer usable non-transitory medium contains a set of instructions for providing content services to a user of a network, wherein the processor is designed to carry out a set of instructions to:
review data returned to a user from the network; and
add content to the returned data,
wherein the added content is selected according to parameters of the user.

12. The data processing system of claim 11, wherein the processor is designed to carry out a set of instructions to:
register the user to the content services prior to reviewing the data.

13. The data processing system of claim 11, wherein the processor is part of an Internet Service Provider network.

14. The data processing system of claim 11, wherein the processor is part of a local browser of the user.

15. The data processing system of claim 11, wherein the processor is designed to carry out a set of instructions to:
provide a software development kit to enable integrating services into the content services.

16. The data processing system of claim 11, further comprising:
a browser of the user to render additional content from the network to complement the content.

17. The data processing system of claim 11, further comprising:
a browser of the user to render additional content from a database located on a dedicated content server to complement the content.

18. The data processing system of claim 11, wherein the processor is designed to carry out a set of instructions to:
prepare the content to the user in a form of a floating desktop.

19. The data processing system of claim 11, wherein the content services is selected from the list consisting of: promotional programs, software downloads, software services, advertisements, targeted commercial content, network service provider related services, search bar, links that appear in a source page called for by the user and suspected as malicious and cloud services.

20. The data processing system of claim 19, wherein the content service is a cash-back program.
